(19) United States
(12) Patent Application Publication
(10) Pub. No.: US 2023/0368125 A1
(43) Pub. Date: Nov. 16, 2023

(54) SYSTEM FOR THE AUTOMATED DISTRIBUTION OF GOODS

(71) Applicant: Vittorio CARLONI, Ancona (IT)

(72) Inventor: Vittorio CARLONI, Ancona (IT)

(21) Appl. No.: 18/265,722

(22) PCT Filed: Dec. 13, 2021
(86) PCT No.: PCT/IT2021/050404

§ 371 Date: Jun. 7, 2023

(30) Foreign Application Priority Data
Dec. 14, 2020 (IT) 102020000030725

(51) Int. Cl. G06Q 10/0836; G06Q 20/12; B65G 1/137

(52) U.S. Cl. CPC G06Q 10/0836; G06Q 20/12; B65G 1/1373

(57) ABSTRACT

The automated distribution system described consists of multiple automated goods collection and delivery stations strategically placed within the distribution area. These stations are equipped with recognition technology for both goods and individuals involved in the collection and delivery process. They are all interconnected through an online network to a software structure. The software structure includes several programs: the System Authorization Manager (SAM) handles user authorization and certification management, the Operational Manager (OM) provides interfaces for managing the distribution of goods, the Global Manager (GM) coordinates the functions of SAM and OM, and the Safety Manager (SM) oversees the recognition technology at each station. The system ensures that every shipment of goods is appropriately identified and associated with the corresponding users, as well as the specific collection and delivery stations involved. By integrating these components, the automated distribution system streamlines the process, enhances efficiency, and improves overall management of goods distribution.

The present invention relates to a goods distribution system, and in particular relates to a system for the automated distribution of goods.

In recent decades, logistics has acquired ever greater importance, also driven by the development of electronic commerce systems, capable of communicating realities that are also very distant from each other, but which nevertheless require the correct material connection at the time of delivery of the purchased goods.

Freight forwarders have improved their control systems for the movement of goods, but the problem remains, however, of synchronizing the ability to receive by the recipient with the ability to deliver by the carrier; often days, or even entire weeks, are lost due to the difficulties associated with establishing a shared meeting point.

In some cases, automated goods distribution systems have been envisaged, which however provide for the management of the entire supply chain, and therefore are unable to integrate, but if ever replace, the existing distribution networks. In general, automated distribution still presents problems related to the security of the authentication of the relationship between sender and recipient.

The aim of the present invention is therefore to provide an automated distribution system that on the one hand is able to integrate with relative ease with the trading and shipping platforms of goods, and on the other hand allows to guarantee the highest level of safety and reliability in management of deliveries.

The object of the present invention is therefore a system for the automated distribution of goods, comprising a plurality of automated stations for the collection and delivery of goods, suitably located in the area involved in the distribution, each station being equipped with means for recognizing goods and people in association with the collection and delivery of goods, each of the stations being connected via the telematic network to a software structure, including a user authorization and certification management program, hereinafter also referred to as the system authorization manager (SAM), a program that groups the interfaces necessary to allow the management of the distribution of goods, hereinafter also called operational manager (OM), a program that coordinates the functions of SAM and OM, hereinafter also called global manager (GM), and a program which manages the means of recognition of goods and persons of each station, hereinafter also called security manager (SM), being each shipment of goods suitably identified and associated with the respective users, as well as associated with the collection station and the delivery station.

The system authorization manager and the operating manager can be provided with a user interface accessible via the telematic network, as well as can be integrated via API to the sales or delivery platforms for goods.

In an executive variant, the automated goods collection and delivery stations are equipped with geo-localization means, and are nodes of a decentralized network managed via DHT (Distributed Hash Table), as well as the servers that implement the software structure of the system according to the present invention. On the one hand, this solution increases the security of the system, and on the other makes it widely scalable in terms of development, since the servers do not need to be connected with all the nodes of the system with which they can instead communicate. Furthermore, malfunctioning or non-functioning nodes can be removed from the system and replaced without harming the communication.

A further object of the invention is an automated goods collection and delivery station integrated in the system described above, comprising a transportable container body, such as a container or the like, which has a storage compartment for the goods collected and destined for delivery, in which they are means for picking up from said storage compartment and positioning means in said storage compartment, said positioning and picking up means being associated with the software structure (OM) of the system according to the present invention, means for recognizing goods and people being provided.

In a preferred embodiment, the picking and positioning means are able to operate independently of each other, as a temporary allocation area for the goods withdrawn and to be delivered is provided in the storage compartment.

Furthermore, said picking and positioning means cooperate with a series of shells of at least two different sizes, suitably selected according to the size of the goods being distributed; the storage compartment will be made in such a way as to accommodate a plurality of each of the elements of the series of shells.

Further advantages and characteristics of the present invention will become evident from the detailed description of some embodiments of the same given, by way of non-limiting example, with reference to the appended drawing tables, in which:

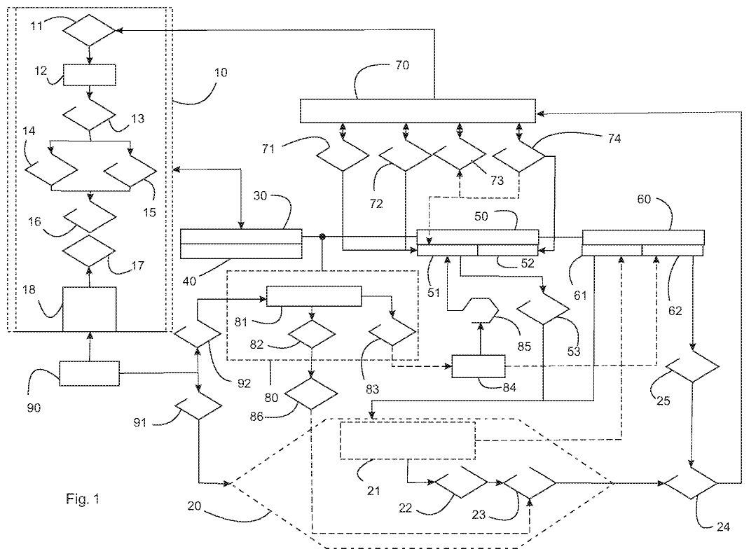

FIG. 1 is a flow chart depicting the operation of the system according to the present invention;

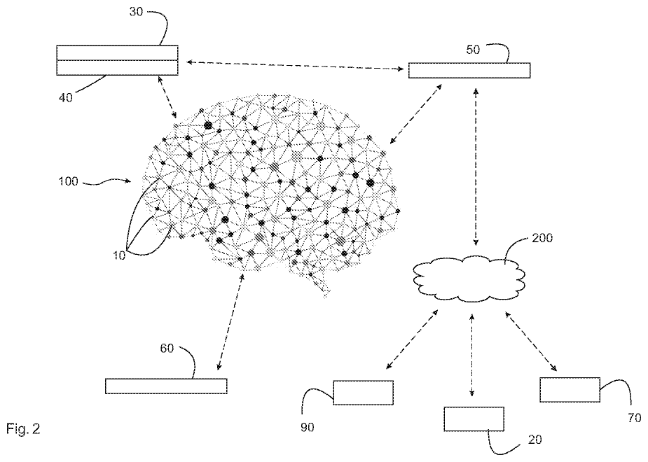

FIG. 2 is a schematic diagram of an executive variant of the system according to the present invention; And

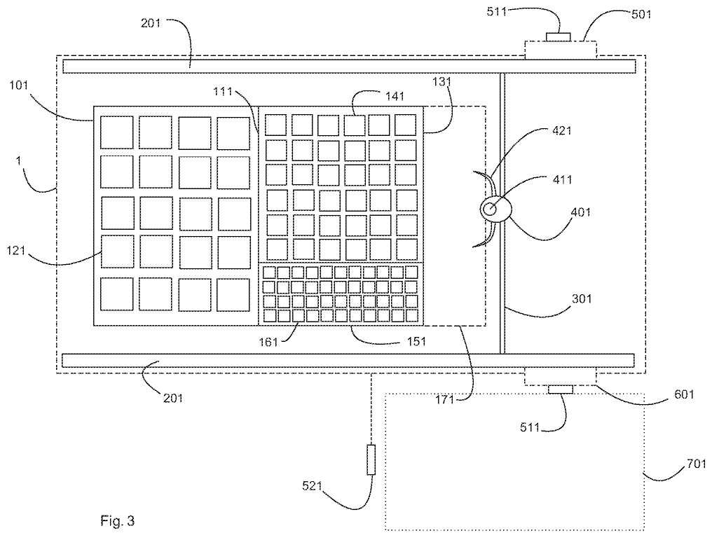

FIG. 3 is a schematic diagram showing an embodiment of the automatic distribution station according to the present invention.

FIG. 1 illustrates the flow chart illustrating the operation of the system according to the present invention. The distribution station 10 is interfaced with the software structure of the system, which includes the global manager 30, associated with the security manager 40, the system authorization manager 50, including the dashboard 51 and the API 52, and the operating manager 60, including dashboard 61 and API 62.

User 90 can access the system through the network application 80, on a PC or mobile, through step 92 of manual entry of the destination station. This happens in the event that the sender user decides to deliver a good to another recipient user; the good will be delivered by the sender directly to the system or to a courier, who will deliver it o the system. The sender enters the information relating to the shipment (81), and the relative authorizations (83) constitute the identity of the sender (84) who signs up for membership in the system through the dashboard 51 of the authorization manager 50. At the same time, the dashboard of the operational manager 60 generates (25), interfacing with the information provided by the sender, the label provided with a code, for example a OR code, which will be positioned on the good (24) to be collected and distributed by the system.

At this point, the sender also authenticates (71) as courier 70, and delivers (11) the good to station 10, which after identifying the sender and the good (12 and 13), and having acquired the data for delivery for direct insertion (14) or by reading the QR code affixed to the good (15), positions it (16) appropriately in the storage compartment. The recipient user will withdraw (17) the good by exhibiting (18) his credentials to the system, which will acquire said credentials under the control of the security manager 40.

Alternatively, the sender charge the delivery to a courier 70 who has signed up to the system (71), and who alternatively can request authorizations for he recognition of its operators to the system (72, 73), or shares its own system (74) of recognition with the system. The courier will then collect the good with the label from the sender, and deliver it to the automated distribution station 10 according to the instructions provided by the sender.

According to another operational variant of the system according to the invention, the user purchases a good from an e-commerce platform 20, which however is not directly interfaced with the system according to the invention. In this case, the web application 80 generates a code corresponding to the address of the user 90, in this case the recipient, which will then be manually entered (86) in the destination data of the good (23) subject of the transaction. The good will then be provided with a label (24), and sent for delivery by the courier, who will interface with the system in the same way as in the previous case.

If, on the other hand, the e-commerce platform 20 is integrated with the system according to the invention, the e-commerce API 21 communicates with the authorization manager 50, via dashboard 51, for the generation 53 of the encrypted keys that allow, in cooperation with the operating manager 60 of the system, to generate the selection (23) of the distribution station integrated with the e-commerce 20, which therefore leads to the generation (25) of the QR label and the evasion of order (24) which can be sent on delivery.

It appears evident that the system according to the invention provides the possibility for the user, whether sender or recipient, to take advantage of an extremely flexible distribution service, which is substantially based on the possibility of having a plurality of automated distribution stations available on the territory which are interfaced with the system. Once the user who has signed up for the system has chosen the station or stations of reference for the transfer of the good, all he has to do is identify himself with the security systems of the station. The system allows interaction with e-commerce platforms both through the communication with the software structure of the system itself, and through the use of the address of the chosen distribution station in a non-integrated platform.

FIG. 2 shows a schematic diagram which illustrates an executive variant of the system according to the present invention; to equal parts correspond equal numerals. In the figure, the automated collection and distribution stations 10 are inserted in a decentralized network 100 managed by DHT; each station constitutes a node of the network, as are nodes the servers on which the global manager 30, associated with the security manager 40, the system authorization manager 50, and the operating manager 60. The system authorization manager 50 controls access through the public network 200, which allows, through an appropriate access portal, the connection to the system of the user 90, of the e-commerce operator 20 and of the courier 70. The system according to the invention will be able to operate according to the methods described with reference to FIG. 1, but with the connection organized in a completely different mode.

On the one hand, the use of a decentralized network implements system security, since violations of the DHT rules are extremely complex; although all nodes are connected via 4 g/5 g network, the routing system does not use address resolution via DNS as it acts on the abstraction of the distributed DHT network above the internet. The DHT network will route the data packets and requests and no one on the internet will ever be able to map the network or access resources in an unauthorized way. On the other hand, this solution makes the system completely scalable, as well as facilitating maintenance and replacement of the various collection and distribution stations.

FIG. 3 illustrates, in a schematic plan from above, an executive form of an automated distribution station integrated into the system according to the present invention; 1 designates the container body of said distribution station. In the body 1 there is a storage compartment 101, divided into the storage area 111 for the shells 121, the storage area 131 for the shells 141, the storage area 151 for the shells 161, and the transit area 171. On the sides of the container body there are the guides 201 in which the crosspiece 301 moves along; the automaton 401 is positioned moving along the crosspiece 301, provided with the axis 411, and associated with the gripping means 421.

The delivery opening 501 is formed on one side of the container body 1, provided with the safety control means 511, while in the diametrically opposite position the withdrawal opening 601 is formed, also provided with the safety control means 511. Both the safety control means and the automaton 401 which controls the gripping means 421 are connected to the global manager 30 of the system according to the invention. On the side of the opening 601 there is a parking area 701 for a vehicle, and the means 521 for the identification of the vehicle are arranged, protruding from the container body 1 and connected to it.

The automated distribution station according to the present invention can be made in the form of a container, and the container can be self-propelled, i.e. provided with a support frame equipped with wheels. The distribution stations according to the present invention can be positioned in the city parking areas, thus in the parking lots of shopping centers or in the service areas along the motorway network. The station can be equipped with two openings for communication with the outside, as well as only one opening can be provided.

The goods are placed in containment shells that have at least two standard dimensions; in the case illustrated there are three different sizes used. This solution allows you to optimize the spaces inside the storage compartment; the size of the asset will determine the choice of the size of the shell by the automaton, which will pick up the appropriate shell and present it to the user; the shell will then be positioned in the appropriate storage area of the storage compartment 101. The global manager 30 of the distribution system according to the invention will have the control of the registers of the presence of the goods in each of the automated distribution stations, associated with the data of the respective recipients, as well as the goods arriving at each distribution station will be recorded.

Different criteria for organizing the spaces within the container body of the single automated distribution station could be considered, but the relevant aspect remains the fact that the apparatus for picking up and positioning the goods interacts only with the shells, thus safeguarding the integrity of the asset from any damage caused by automatic handling. The transit area allows the management of collection and delivery activities at the same time, allowing the automaton to arrange empty and full shells in their respective storage areas once the interface activities with users have been completed, The safety level of the safety control devices 511 can be established during the system implementation phase; clearly, an automated distribution system must provide for a sufficiently high level of security, both for the security relating to the delivery of goods to the actual recipients, and for the security and integrity of the distribution system itself. Consequently, facial recognition systems or similar biometric systems will be used, or enabling systems through the transmission of codes. The parking area 701 adjacent to the opening 601 is monitored by the control means 521, which are able to check the characteristics of the vehicle associated with the user (model, plate), in such a way as to possibly allow delivery or collection of the good.

1. System for the automated distribution of goods, comprising a plurality of automated goods collection and delivery stations (10), suitably located in the area involved in the distribution, each station being equipped with means of recognition of goods and people in association with collection and delivery of the goods, each of the stations being connected via an online network to a software structure, including a user authorization and certification management program, hereinafter also referred to as the system authorization manager (SAM), a program that groups the necessary interfaces to allow the management of the distribution of goods, hereinafter also referred to as operational manager (OM), a program that coordinates the functions of SAM and OM, hereinafter also referred to as global manager (GM), and a program that manages the means of recognition of goods and people of each station, hereinafter also called safety manager (SM), being there any shipment of goods suitably identified and associated with their respective users, as well as associated with the collection station and the delivery station.

2. System according to claim 1, in which the system authorization manager and the operating manager are provided with a user interface accessible via an online network.

3. System according to claim 1, in which the system authorization manager and the operating manager have integrations via API to the sales or goods delivery platforms.

4. System according to claim 1, in which the automated goods collection and delivery stations (10) are equipped with geo-localization means and are nodes of a decentralized network (100) managed via DHT (Distributed Hash Table), as well as the servers that implement the software structure of the system are nodes of this network.

5. System according to claim 4, in which the system authorization manager controls the user access interface from the public online network to the decentralized network (100).

6. Automated goods collection and delivery station inserted in the system according to claim 1, comprising a transportable container body, such as a container or the like, which has a storage compartment for the goods withdrawn and intended for delivery, in which means for picking up from said storage compartment and positioning means in said storage compartment are arranged, said positioning and picking up means being associated with the software structure (OM) of the system according to the present invention, means for recognizing goods and people.

7. Automated station according to claim 6, in which the picking and positioning means are able to operate independently of each other, a temporary allocation area of the goods withdrawn and to be delivered being provided in the storage compartment.

8. Automated station according to claim 6, in which said picking and positioning means cooperate with a series of shells of at least two different sizes, suitably selected according to the size of the goods being distributed; the storage compartment will be made in such a way as to accommodate a plurality of each of the elements of the series of shells.
